(19) United States
(12) Patent Application Publication
(10) Pub. No.: US 2022/0393638 A1
(43) Pub. Date: Dec. 8, 2022

(54) Movable Shingle Arrangement of Rectangular Strip Modules Comprising a Covering of Crystalline and Thin-Layer Solar Cells

(71) Applicant: Thomas Rösener, Dresden (DE)

(72) Inventor: Thomas Rösener, Dresden (DE)

(21) Appl. No.: 17/612,292

(22) PCT Filed: Nov. 20, 2020
(86) PCT No.: PCT/DE2020/100987

§ 371 Date: Nov. 18, 2021

(30) Foreign Application Priority Data
Nov. 21, 2019 (DE) 10 2019 131 541.7

(51) Int. Cl. H02S 20/30; H02S 30/20; H02S 40/36

(52) U.S. Cl. CPC H02S 20/30; H02S 30/20; H02S 40/36

(57) ABSTRACT

The invention relates to a movable shingle arrangement of rectangular strip modules comprising a covering of solar cells on carrier materials that differ according to choice, such that the shingle arrangement can be arranged in such a way as to allow it to be unfolded, extended or set up as a canopy. The problem addressed is that of providing a novel connecting structure for a movable shingle arrangement, wherein supporting structures for mounting and displacement purposes are formed on an arranged system of rails that can be extended or swung out. The shingle arrangement (1) according to the invention consists of coupled rectangular strip modules (2), which are covered with crystalline and thin-layer solar cells (3) and overlap one another. A system of rails (6, 21) is arranged along at least two outer edges (18). Formed under the system of rails (6, 21) are supporting structures suitable for mounting and guiding purposes. Arranged on the rectangular strip modules (2) is/are one, two or more rows of solar cells (3), which are arranged next to one another and are interconnected in such a way that there is a maximum possible surface coverage with active photovoltaic solar-cell material. In the extended state, the rectangular strip modules (2) overlap like shingles. Along at least one long side (19) of the rectangular strip module (2), a defined perforated structure made up of depressions or through-openings (9) is arranged in such a way that elevations, balls or pins (10) of an adjacently arranged rectangular strip module (2) engage in this perforated structure, and so a mechanically stable connection is produced. The rectangular strip modules (2) are coupled to one another by means of a cable pull or a system of rails (5) in such a way that they can be extended or retracted manually or automatically. In the pulled-in or retracted state, the rectangular strip modules (2) arranged longitudinally or transversely alongside one another lie one above the other in a stack or one alongside the other in a shingle box (23). The rectangular strip modules (2) may be set up for example in an upwardly sloping manner by means of a system of double rails, in order to make an optimum energy yield possible.

### CROSS REFERENCE TO RELATED APPLICATIONS

This application is the U.S. national stage of International Application No. PCT/DE2020/100987, filed on 2020 Nov. 20. The international application claims the priority of DE 102019131541.7 filed on 2019 Nov. 21; all applications are incorporated by reference herein in their entirety.

### BACKGROUND

The invention relates to a movable shingle array comprised of rectangular strip modules fitted with crystalline and thin-film solar cells connected in series or in parallel on optionally different carrier materials, along which on at least two outer edges under the solar module there are support structures for holding and adjusting in an extendable and/or fold-out rail system, so that the rail system can be folded out, extended or set up as a canopy.

From DE 10 2012 024 135 A1, a solar awning for caravans or mobile homes is known which consists of at least a rigid or flexible solar module with a folding and unfolding mechanism and which is provided with a retraction and extension mechanism and a set-up and collapsing mechanism. The awning is fixed to the roof or the wall of a vehicle with a fixed element and has an overall mechanism for folding and unfolding. This solar awning is to produce electrical energy, protects from the sun, shields from rain, and is permanently attached to a vehicle. It can be folded up for transport and is also suitable for attachment to walls or roofs, although this type of solar awning is relatively inflexible in terms of use. The individual solar modules are attached to one another via an elaborate hinge construction.

WO 9221152 A1 shows a solar system for use in a series of solar panels which can be fastened to a roof substructure, each panel being connected to an adjacent side of the next solar panel via a protruding seam cover. In this case, a massive, wide base beam is used, which has a front surface and a rear surface for attachment to the roof substructure. There are protruding seam caps arranged on the longitudinally extending side edges, which are firmly screwed to the lateral solar panels, so that collapsing or folding or unfolding is not possible. On the lower edge, protruding lips extending over the entire width are arranged so that the individual solar panels overlap like shingles and are thus connected in a weatherproof manner.

EP 2 020 467 A1 describes an outdoor awning with panels for the use of solar energy, in which a fixed support structure is arranged for several crossbars, which can move longitudinally along guide rails that are formed within a fixed support structure to be able to open and close the awning. Each crossbar is rigidly connected to the underside of a canopy in such a way that the canopy has several individual crossbars, each of the crossbars being delimited by a pair of successive crossbars (3). Several solar panels are arranged on the foldable canopy. These solar panels, which can be stretched, are exposed to sunlight to absorb the rays, and convert energy with this folding awning. In addition to generating energy, this folding awning protects against direct sunlight and protects against the effects of the weather, especially rain. However, this type of awning can only be arranged in a certain roof pitch, so that it is not possible to set an optimal angle with respect to the entering solar rays, which means that the energy yield is not too high and fluctuates considerably over the course of the day.

### SUMMARY

The object of the invention is to create a novel connection structure for a movable shingle array made of rectangular strip modules fitted with crystalline and thin-film solar cells on optionally different carrier materials, along which on at least two outer edges under the solar module there are support structures for holding and adjusting an extendable or fold-out rail system, whereby this shingle array enables a high energy yield, guarantees a partial or complete shading area, offers weather protection, requires little space, is easy to build and easy to use and has a long service life.

The object according to the invention is achieved through the characteristics of the preamble and characteristic part of the first patent claim or thirteenth patent claim. Further advantageous embodiments are described in the dependent claims referring back to them. The movable shingle array 1 according to the invention consists of the known rectangular strip modules 2, which are coupled to one another and are fitted with crystalline and thin-film solar cells 3 and which overlap.

### DETAILED DESCRIPTION

Suitable carrier materials for the thin-film solar cells 3 can usually be thin glass, GRP, CFRP or plastics. An extendable and retractable rail system 6, 21 is arranged along at least two outer edges 18. Under the rail system 6, 21, which is preferably designed as a split, mutually displaceable double rail system consisting of at least two double rails 11 and in which each rectangular strip module is supported and guided in both rails 11.1 and 11.2 and can thus be erected, this arrangement shows structures suitable for guiding and holding it. On the rectangular strip modules 2, one row, two rows or several rows of crystalline or thin-film solar cells 3 are arranged next to one another, interconnected in such a way that the maximum possible area is occupied with active photovoltaic solar cell material. The dimensions of the rectangular strip modules 2 usually correspond to the commercially available, graduated sizes of the individual thin-film solar cells 3, depending on the size of the shingle array. Rectangular strip modules 2 are constructed in such a way that these two or, if necessary, several rectangular strip modules 2 in the extended state still slightly overlap in the manner of shingles to be able to ensure a closed roof surface, rainwater tightness with sufficient mechanical stability. Depending on the design, various contacts are formed on the outside of each rectangular strip module 2 in which a bypass diode is integrated, each rectangular strip module 2 being individually contacted and connected. The contacts are arranged either directly on one of the short sides 20 or also on both sides laterally in or on the rectangular strip module 2 or in one of the rails. Along at least one long side 19 of the rectangular strip module 2, a defined hole structure consisting of depressions or through openings 9 is arranged in such a way that elevations, balls, or pins 10 of the next rectangular strip module 2 (for example, combined studs/spikes or a snap-in ball/snap-in recesses) engage in this hole structure so that a mechanically stable connection is created. The rectangular strip modules 2 are coupled to one another via a cable pull or a rail system 5 in such a way that they can be pulled out or pulled in by hand or automatically. In the extended state, the individual rectangular strip modules 2 form a continuous overlapping shingle roof. In the retracted state, the rectangular strip modules 2 arranged lengthwise or crosswise next to one another lie in a stack on top of one another or next to one another in a shingle box 23, so that they have a minimal space requirement and can be secured against slipping or stably fixed as a kind of tied package without any problems. The rectangular strip modules 2 can not only be moved into the fully extended position either by means of the cable pull or also via a suitable internal rail system 5, but can also be set up at an angle, for example by means of a double rail system, for the purpose of optimal use of the sun rays, i.e., with the shingle roof partially open. Depending on the technical design of the shifting mechanism, it can be set up either manually or automatically, such as, in particular, controlled by sensors. This results in an optimal set-up or alignment according to the respective height of the sun. It is also possible, for example if the shingle array 1 is coupled on one side via a hinge structure 12 to a vehicle or wall surface 17, that the entire shingle array 1 can be swiveled and aligned laterally according to the position of the sun during the day to achieve an optimal energy yield.

Optionally, the movable shingle array 1 made up of rectangular strip modules 2 fitted with crystalline and thin-film solar cells 3 can be formed from rectangular strip modules as a single-surface, two-surface or multi-surface shingle roof, i.e., by arranging one or more intermediate rails 21 for subdivision and for reasons of stability. This allows the size of the covered area to be adapted to the respective requirements.

It is particularly advantageous for a high energy yield if the shingle array 1 fitted with crystalline and thin-film solar cells 3 can be set up and aligned, depending on the embodiment, according to the angle of sunlight, either by hand or automatically via a suitable supporting telescope construction 15. As is known, the energy yield is highest when the sun rays strike the crystalline and thin-film solar cells 3 almost perpendicularly.

Likewise, the movable shingle array 1 made of rectangular strip modules 2 fitted with crystalline and thin-film solar cells 3 can be designed in a particular embodiment so that it can be set up manually or automatically so that the shingle array 1 can be set up as a complete closed shingle roof at a height depending on the angle of solar radiation, which means it is placed accordingly as a closed roof construction inclined or erected upwards or downwards—depending on the position of the sun—in a flatter position to enable an optimal energy yield.

In principle, it is also possible that in the movable shingle array 1 the individual rectangular strip modules 2 are only partially fitted with crystalline and thin-film solar cells 3 or that only every second rectangular strip module 2 is so equipped. Although this indeed reduces the energy yield accordingly, the lighting conditions are considerably improved under the shingle array, the shadowing is less, although weatherproofing can still be guaranteed in good lighting conditions.

For safety reasons, it is useful if the movable shingle array 1 is formed of rectangular strip modules 2 fitted with crystalline and thin-film solar cells 3 with one or more sensors, i.e., that the shingle array 1 is then monitored by sensors. It is advantageous if, for example, at least one rain sensor is arranged so that when the rectangular strip modules 2 are erected, i.e., with the shingle roof partially open, the rectangular modules 2 are laid flat and rainproof conditions can be achieved. In addition, at least one further sensor can also be arranged which monitors the attacking wind loads in the event of a storm and warns in good time in order, for example, to prevent destruction of the entire shingle array 1 in the assembled state. It is thus possible to automatically retract or fold in the shingle roof in the event of danger, triggered by a sensor, with appropriate motorized actuation via cable pull or suitable motor-operated mechanics or an inner rail system 5 to be able to reliably avoid damage to the shingle roof system.

The usage properties of the movable shingle array 1 made up of rectangular strip modules 2 fitted with crystalline and thin-film solar cells 3, i.e., of the shingle roof according to the invention, can be further increased if lighting, such as lighting by means of energy-saving LED elements, is also arranged under the shingle roof.

It is also conceivable if, with an arrangement of the movable shingle array 1 made of rectangular strip modules 2, the extendable shingle array 1 is arranged on both sides of the longitudinal sides of a vehicle or also on three sides, i.e., on the two longitudinal sides and on the rear of the vehicle. It can be extended individually to one side, to two sides or to all three sides.

It can also be advantageous if the movable shingle array 1 made of rectangular strip modules 2 is arranged on a vehicle, or for example on a wall or a building wall or wall surface 17, so that the shingle array is arranged around the articulated construction 12 so that it can be locked on one side only and, including the support structure, can be pivoted through an angle of up to 90°. Then, for example in a vehicle configuration, without having to park the vehicle, optimal alignment depending on the position of the sun is possible. Ideal alignment can also be achieved in this simple way by pivoting it on a fixed house wall. The prerequisite is that there is sufficient space for the area covered by the shingle roof.

Usually, each rectangular strip module 2 in this movable shingle array 1 fitted with crystalline and thin-film solar cells 3 with a bypass diode is individually interconnected and connected to an intermediate DC/AC converter with an energy collection unit via suitable busbars or connecting lines.

The contacting of the rectangular strip modules 1 in the movable shingle array 1 according to the invention for the dissipation of the current generated by the crystalline and thin-film solar cells 3 in the individual rectangular strip modules 2 takes place, depending on the embodiment, preferably via contacts arranged in the longitudinal rails 6, such as spring contacts or via pin contacts in the longitudinal rails 6 or via individual plug connections or via sliding contacts, which are connected with busbars or via connection lines with the energy collection unit or with suitable consumers.

To enable better protection from the weather or additional privacy from one, two, or all three sides, the movable shingle array 1 made of rectangular strip modules 2 fitted with crystalline thin-film solar cells 3 on or under the lateral outer edges 18 and the possibly arranged front rail 7 and partially or completely enveloping the support structure can, if necessary, also be opened individually, and additional tent tarpaulins can be placed for lateral or all-round weather protection.

The movable shingle array 1 of rectangular strip modules 2 fitted with crystalline and thin-film solar cells 3 enables a high energy yield, regardless of the different carrier materials on which the crystalline and thin-film solar cells 3 are placed, with this universal shingle roof being of simple construction and having the option of being very filigree and lightweight. As a result, it can easily be attached to vehicles of different sizes or any wall construction, and a large, usable, active, electricity-generating solar surface can also be implemented. Depending on the design, it guarantees partial or complete shading, offers sufficient protection from the weather, requires little space and is easy to assemble and dismantle. The energy generated can be stored in a suitable energy collection system, such as, for example, in an appropriately sized vehicle battery.

In a very simple embodiment of the invention, the movable shingle array according to the invention can consist of an intermateable shingle array 1 of individual rectangular strip modules 2, which can be easily assembled by hand, fitted with crystalline and thin-film solar cells 3 on optionally different carrier materials. Here, along at least two outer edges 18 under the rectangular strip modules 2, suitable support structures are arranged for holding and adjusting in an extendable or fold-out telescopic support system 5 which is arranged underneath if necessary. One row, two rows or several rows of crystalline or thin-film solar cells 3 arranged next to one another can be interconnected and arranged to form a rectangular strip module 2. The two or more rectangular strip modules 2 are plugged or clicked together in such a way that they overlap in a shingle-like manner when they are extended as assembled here. Contacts are formed on the outside of each rectangular strip module 2 on the short side 20, with the contacts 11 on the short side 20 being arranged directly laterally in or on the rectangular strip module 2 or in the inner rail system 5. Each rectangular strip module 2 is individually contacted and interconnected. Along a long side 19 of the rectangular strip module 2, a defined hole structure consisting of depressions or through-openings 9 is arranged, with elevations or pins 10 of the respective next arranged rectangular strip module 2 engaging in the depressions or openings 9 of the hole structure (for example, by means of studs/spikes or a snap fastener connection). The rectangular strip modules 2 are manually plugged together, fixed, and thus mechanically connected to one another via the depressions or through openings 9 and the corresponding elevations or pins 10 to form a shingle roof. The individual assembled rectangular strip modules 2 form a closed shingle roof and the rectangular strip modules 2 are connected via separate flexible, externally insulated copper connectors, usually flexible flat connectors, via one or two laterally arranged busbars or cables and connected to an energy collection unit or connected consumers via an electrical control center. Depending on the embodiment, this manually mountable kit can be quickly assembled on site and attached to a wide variety of vehicles, frames, structures, walls, balconies, etc. by means of a separate support structure. This shingle array 1 is connected to an energy collection unit, which also contains the other necessary circuit technology, such as DC/AC converter or control electronics.

### BRIEF DESCRIPTION OF THE DRAWINGS

The invention is shown in an exemplary embodiment in FIGS. 1 to 10 in several variants.

FIG. 1 shows a vehicle with shingle arrays 1 arranged on the left and right

FIG. 2 shows a three-surface shingle array 1 as a top view

FIG. 3 shows a raised three-surface shingle array 1 freestanding

FIG. 4 schematically shows a side view and front view on a wall

FIG. 5 shows a single-surface shingle array 1 with two rows of side by side arranged and interconnected crystalline and thin film solar cells 3 with 8 thin-film solar cells 3 per row during an extension process

FIG. 6 shows a single-surface shingle array 1 with two rows of side by side arranged and interconnected crystalline and thin film solar cells 3 in a flat inclination of the rectangular strip modules 2 to facilitate optimal entry of solar rays.

FIG. 7 shows a two-surface shingle array 1 with a row of side by side arranged and interconnected crystalline and thin film solar cells 3 in a steeply sloping inclination of the rectangular strip modules 2 to facilitate optimal entry of solar rays.

FIG. 8 shows a two-surface design of more than 90 degree adjustable, i.e., in opposite directions, rectangular strip modules 2 each with 8 crystalline and thin film solar cells 3 in a row per rectangular strip module 2

FIG. 9 shows a very simple, manually assemblable embodiment of a shingle array 1 without a frame and without a stand for setting up or aligning and without accessories

FIG. 10 shows a raised three-surface shingle array 1 installed on a wall surface 17 with a simple joint construction (here with a hinge design for swiveling up to 90 degrees to the left

FIG. 11 schematically shows a double rail 11 for setting up the six rectangular strip modules 2 attached thereto.

### DETAILED DESCRIPTION OF THE PREFERRED EMBODIMENTS

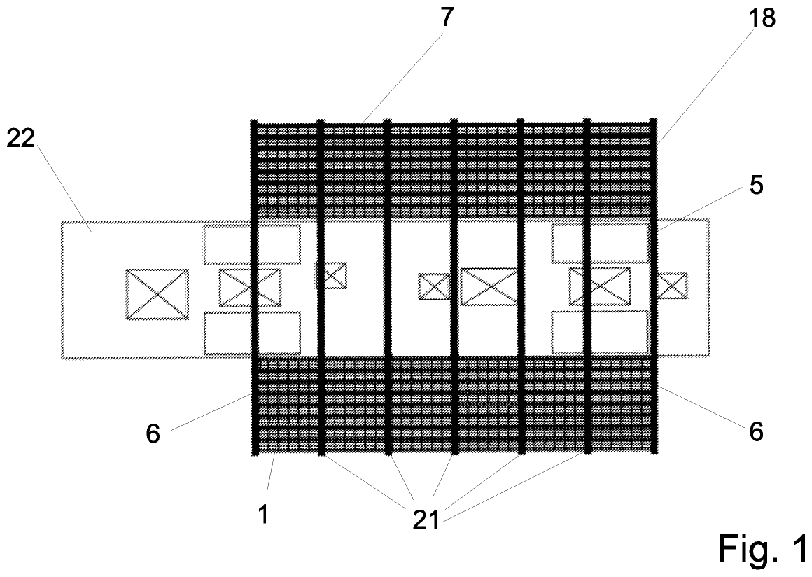

FIG. 1 shows a possible embodiment variant of a vehicle 22 with extended shingle arrays 1 arranged on the left and right, where a continuous extendable or retractable profiled system of telescopic rails is arranged above the roof of a vehicle 22, such as a caravan. The rail system here consists of two telescopic/retractable longitudinal rails 6 and five telescopic/retractable intermediate rails 21, inside of which a rail system 5 is arranged for guiding and holding rectangular strip modules 2 and which also extend over the entire width of the vehicle over the roof of the vehicle. These are shown here in this FIG. 1 in the extended state. The inner rails are designed as intermediate rails 21, i.e., they have two guides on both sides for the attachment and guidance of the individual rectangular strip modules 2 which overlap like shingles. In the intermediate rails 21, busbars to the power line are also arranged on one side or, depending on the embodiment variant, on both sides (not shown). The intermediate rails 21 are generally trough-shaped and designed to be watertight at the bottom, so that they also serve to drain water. However, depending on the design, a separate sealing cover can also be formed at the top.

A six-surface shingle array is unfolded or extended on each side of the vehicle. In the folded or retracted state, the longitudinal rails 6 and intermediate rails 21 are so long that they cannot protrude beyond the width of the vehicle. If the longitudinal rails 6 and the intermediate rails 21 can be telescoped several times, it is also possible to store the folded shingle arrays exactly in the middle of the longitudinal axis of symmetry of the vehicle. As a rule, however, they are stored, secured, and carried along in the edge area of the vehicle roof. Skylights are shown on the vehicle roof (these are not numbered). The rail system is mounted centrally across the width of the vehicle, so the center of gravity is balanced when driving, with the load being evenly distributed. Due to the subdivision into a multi-part rail system, there is the possibility of flexible extension. The shingle roof can therefore be extended separately on each side of the vehicle.

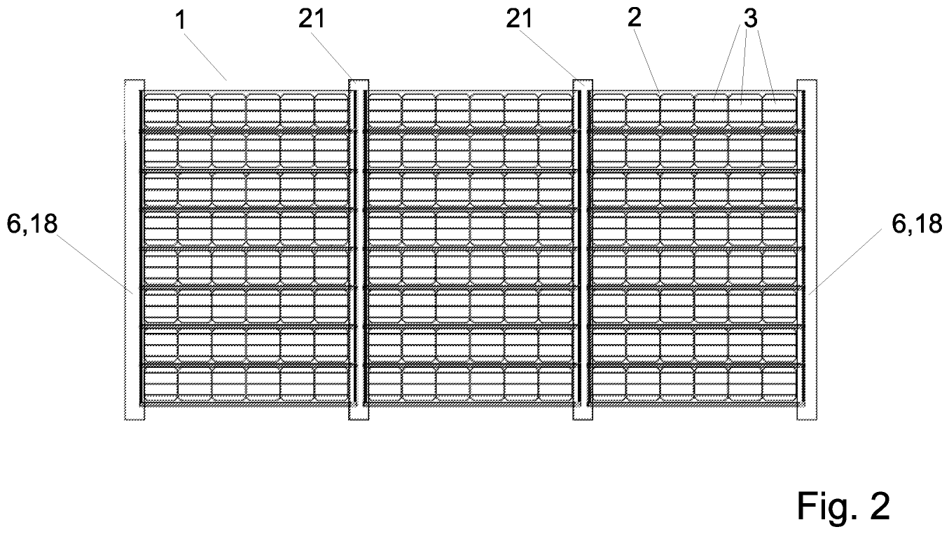

FIG. 2 shows a three-surface shingle array 1 as a plan view; multi-surface shingle arrays can also be made. Per shingle surface 8 rectangular strip modules 2 with 6 crystalline as well as thin-film solar cells 3 each overlap. The two middle rails 21 are trough-shaped and serve at the same time to drain water when it rains. The contact in the center rails 21 and the current dissipation by means of suitable busbars takes place in a separate channel, which is insulated against the ingress of moisture. The two longitudinal rails 6 on the outer edges 18 are suitably clad from the side.

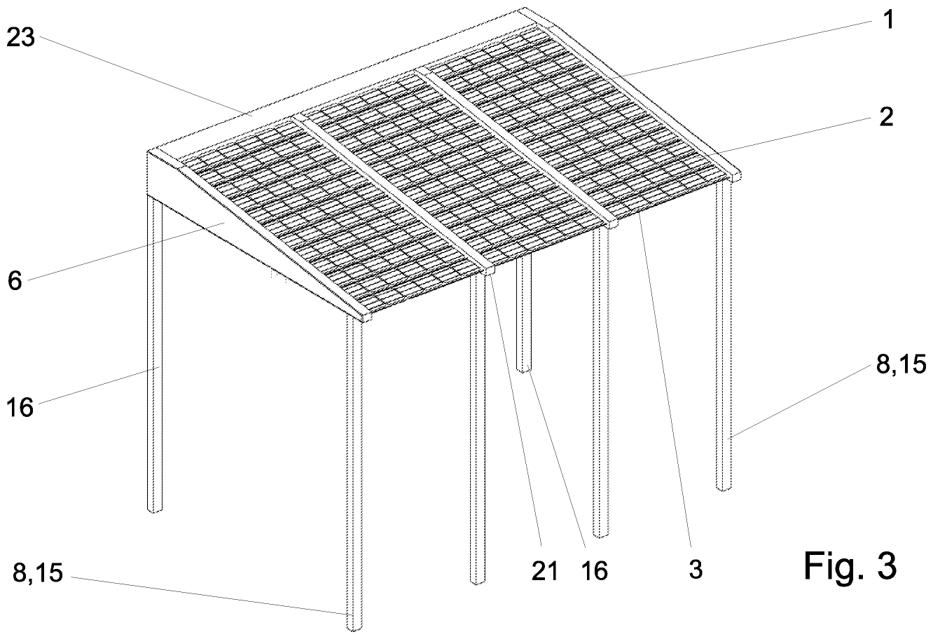

FIG. 3 shows a simple raised three-surface shingle array 1 freestanding without vehicle or wall surface 17. Each surface consists of 12 expandable and retractable or foldable, or erectable and dismantlable rectangular strip modules 2 each with 6 interconnected crystalline and thin-film solar modules 3. The rectangular strip modules are guided and contacted on the left and right in the two longitudinal rails 6 and in the two intermediate rails 21. The shingle array 1 is erected here, for example, by means of a telescopic support system 15, which consists of normal telescopic supports 8 and extendable telescopic wall supports 16. However, rigid supports can also be used. The telescopic wall supports 16 are generally not required in an arrangement on a vehicle or wall surface and can be omitted if desired. The longitudinal rails 6 can also be telescoped as a rule (not shown in the drawing). In the retracted or folded state, the twelve rectangular strip modules 2 are stored one above the other in the shingle box 23, so that there is minimal space requirement.

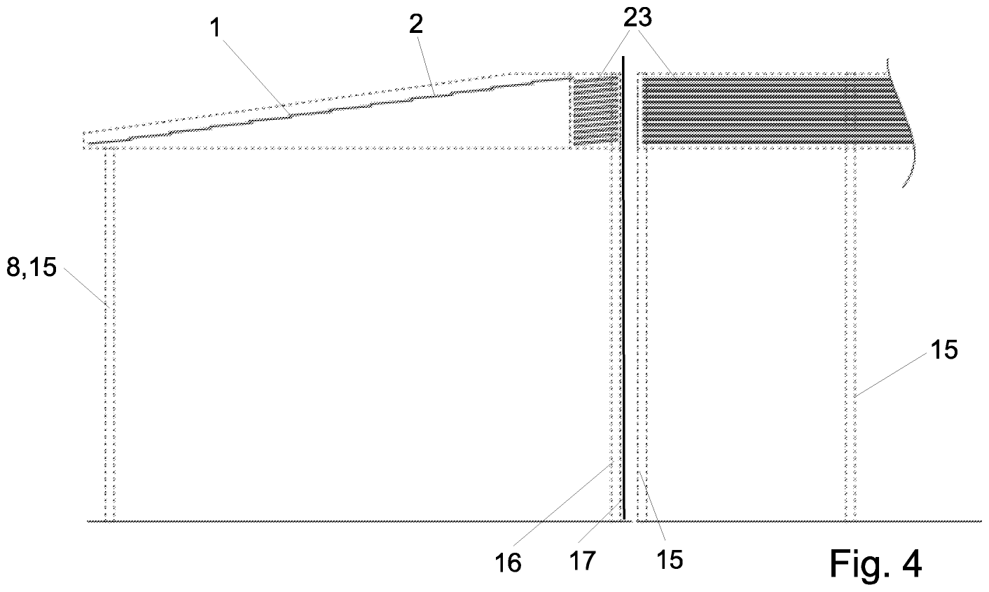

FIG. 4 schematically shows a side view on a wall and a front view with 12 rectangular strip modules 2 of a shingle array 1 according to the invention which can be collapsed to form a package, and which can be stored in a shingle box 23. The number of telescopic supports 8 of the telescopic support system 15 generally corresponds with the number of telescopic longitudinal rails 6 and the number of intermediate rails 21 arranged in each case. In the case of a single-surface or two-surface design, two telescopic supports 8 at the two corners are generally sufficient at the front. The extendable telescopic wall supports 16 can, but need not be, used if the shingle roof system 1 is anchored in the vehicle or wall surface 17, for example, in a sufficiently firm and statically secure manner.

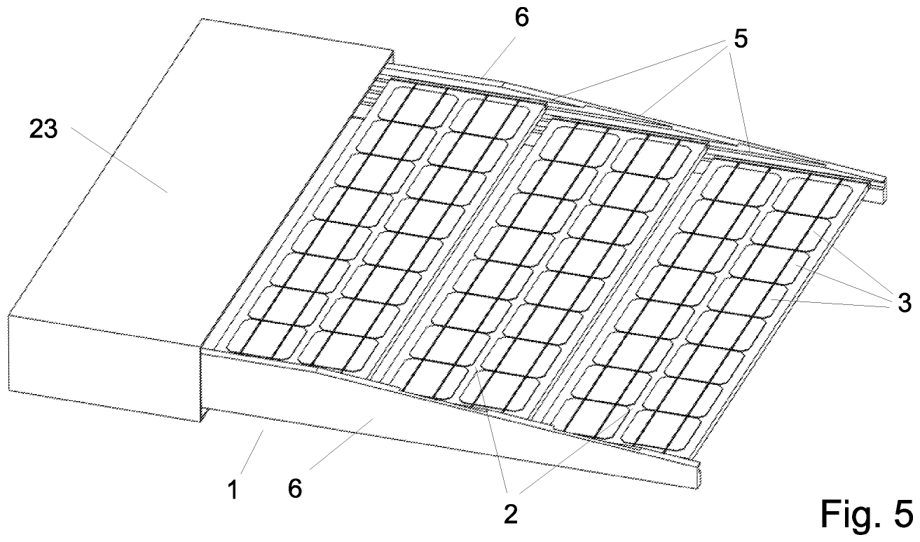

FIG. 5 shows a single-surface shingle array 2 with two rows of crystalline and thin-film solar cells 3 arranged side by side and interconnected with each other, each on a rectangular strip module 2 during extension. The three rectangular strip modules 2 here, which in the extended state can overlap like shingles, are guided, and supported on the inside in the two longitudinal rails 6 in a rail system 5 adapted to the number of rectangular strip modules. These are suitably interconnected and connected to an energy store.

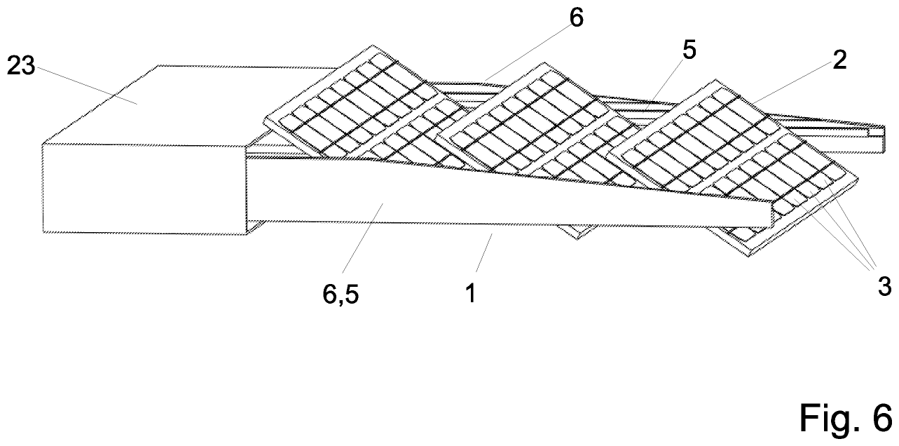

FIG. 6 also shows a single-surface shingle array 1 with two rows of crystalline and thin-film solar cells 3 arranged side by side and interconnected with each other per rectangular strip module in a flat inclined position of the rectangular strip modules 2 to enable optimum radiation incidence. The inclination is generally interlinked through cams and a cable pull with the aid of a specially designed rail system 5 for guiding the rectangular strip modules 2. It is advantageous if the strip rectangle modules 2 can then be pulled further apart to be able to use of the entire surface (including those of the bottom row) of the crystalline and thin-film solar cells 3. This means that the longitudinal rails 6 must be made longer to be able to further enlarge the distances between the rectangular strip modules compared to the shingling position. The shingle box 23 is then to be made correspondingly wider.

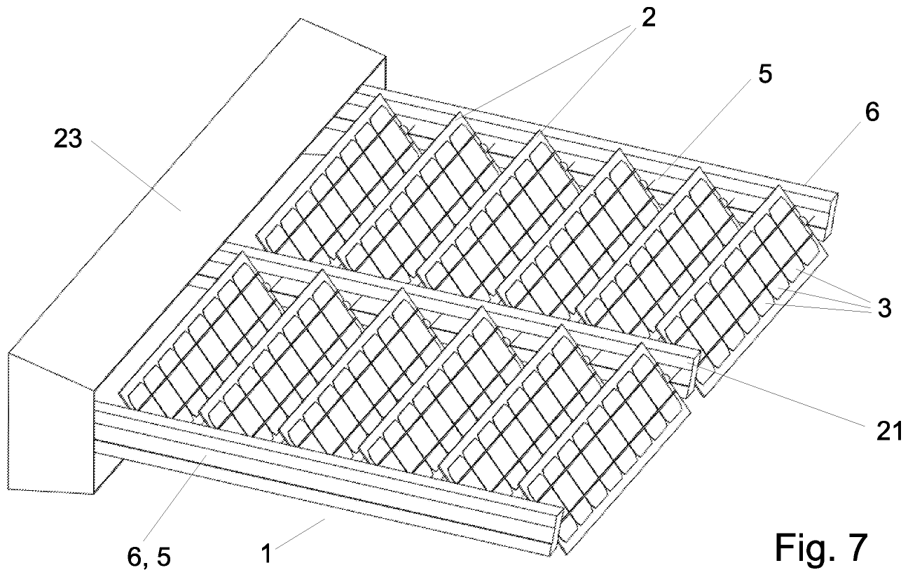

FIG. 7 shows a single-surface shingle array 1 with a number of crystalline and thin-film solar cells 3 arranged side by side and interconnected with each other per rectangular strip module in a flat inclined position of the rectangular strip modules 2 to enable optimum radiation incidence. Here, too, the two telescopic/extendable and telescopic/retractable longitudinal rails 6 and the telescopic/extendable and telescopic/retractable intermediate rail 21 are preferably designed to be longer to allow inclined positioning by means of the specially designed rail system 5 and to ensure optimal distances between the rectangular strip modules 2 for optimal uniform irradiation of all crystalline and thin-film solar cells 3. The two longitudinal rails 6 and the central rail 21 here preferably consist of a double rail system which can be displaced relative to one another, and which can be adjusted via an oval adjusting disk. This is also advantageous because the solar cells 3 are illuminated evenly and have almost the same temperature, which avoids tension within each row of solar cells 3 due to temperature fluctuations. The shingle box 23 is not too wide but is designed to be higher, since the rectangular strip modules 2 are stored upright in the shingle box 23 here.

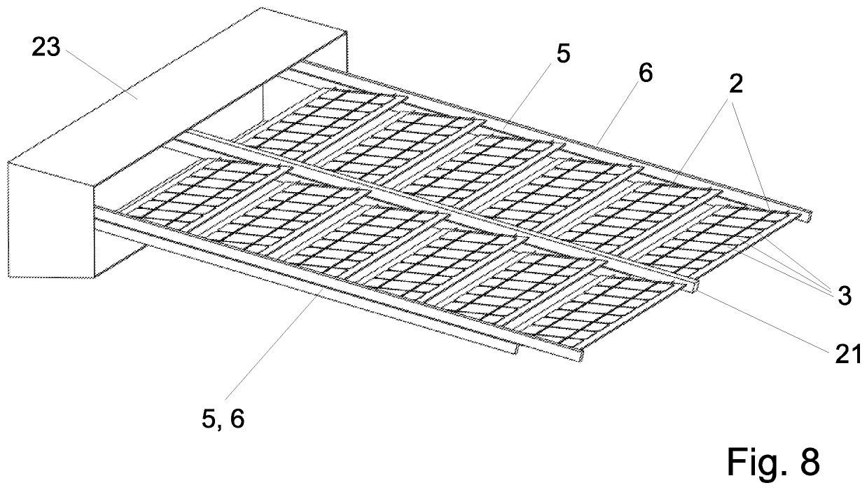

FIG. 8 shows a two-surface design of rectangular strip modules 2 adjustable by more than 90 degrees, i.e., which can be set up in opposite directions, each with 8 crystalline and thin-film solar cells 3 arranged in a row per rectangular strip module 2. The 6 rectangular strip modules arranged here are provided with elevations 10 and recesses 9 alternately on their surface along their two long sides 19. Likewise, recesses 9 and elevations 10 are alternately arranged on the back of the rectangular strip modules 2 along the long sides 19, which correspond with the recesses 9, so that they each interlock in the shingled position and ensure stability.

If they are pulled apart further, the rectangular strip modules 2 can be set up and aligned with their active sides, which are fitted with solar cells, to the front or to the rear, depending on the position of the sun. It is also useful to form the two divided longitudinal rails 6 and the divided central rail 21 to be pivotable downwards or upwards within a certain angular range. This makes it possible to set the shingling forward at an angle away from the fastening point of the shingle box 23. Then, the rain runs away from the shingle box 23 towards the front. On the other hand, the shingling can also be set up in the other direction. Then, the inclination is backwards in the direction of the shingle box. This means that rain is diverted backwards toward the shingle box. This design is only useful for certain arrangements, such as when mounting on vehicles or balconies. To make this possible, the two longitudinal rails 6 and the central rail 21 are designed to be divided and can be pulled out so far that the rectangular strip modules 2 can be pulled apart beyond the shingle position and set up in the desired direction and position. Depending on the position of the sun, the rectangular strip modules 2 can also be set up steeper (open, non-rainproof position) toward the front away from the shingle box 23 or toward the shingle box 23. The rail system 5 is designed so that this is possible accordingly. However, the variant can also be implemented in which the shingling can only be adjusted in one direction but an optimal inclination—depending on the position of the sun—is possible in both directions. The divided rails 11.1 and 11.2 are extended and adjusted, for example, via an oval turntable mechanism, to set an optimal inclination in terms of solar radiation.

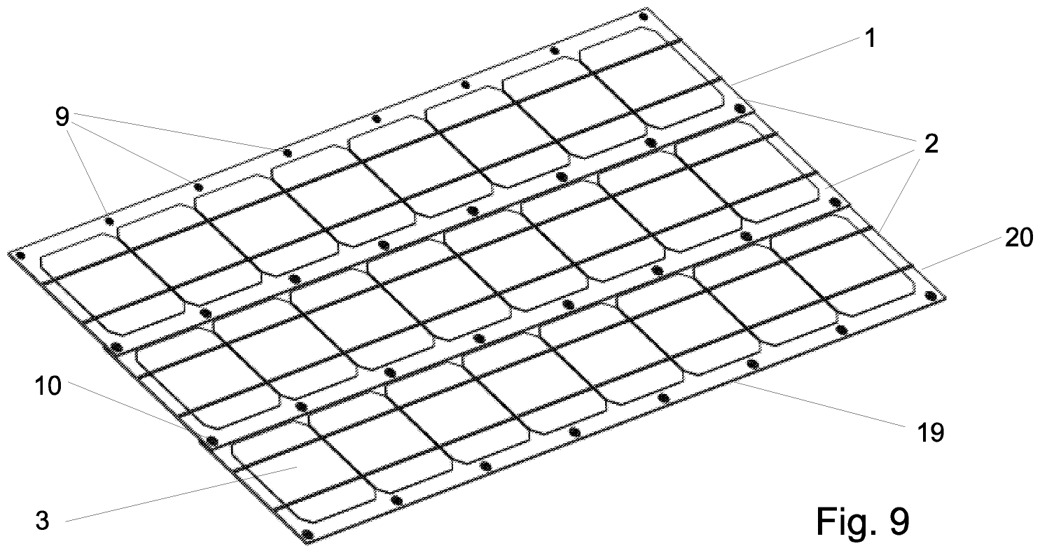

FIG. 9 shows a very simple manually assemblable embodiment consisting of three rectangular strip modules 2, without a frame and without a stand, for setting up or aligning and without any other accessories. This modular system, which then includes at least two lateral longitudinal rails 2 and a suspension device or a setup device with busbars or a connection cable for current dissipation and an energy storage unit, is easy to transport, easy to assemble or set up, and requires only a very small amount of space during transport.

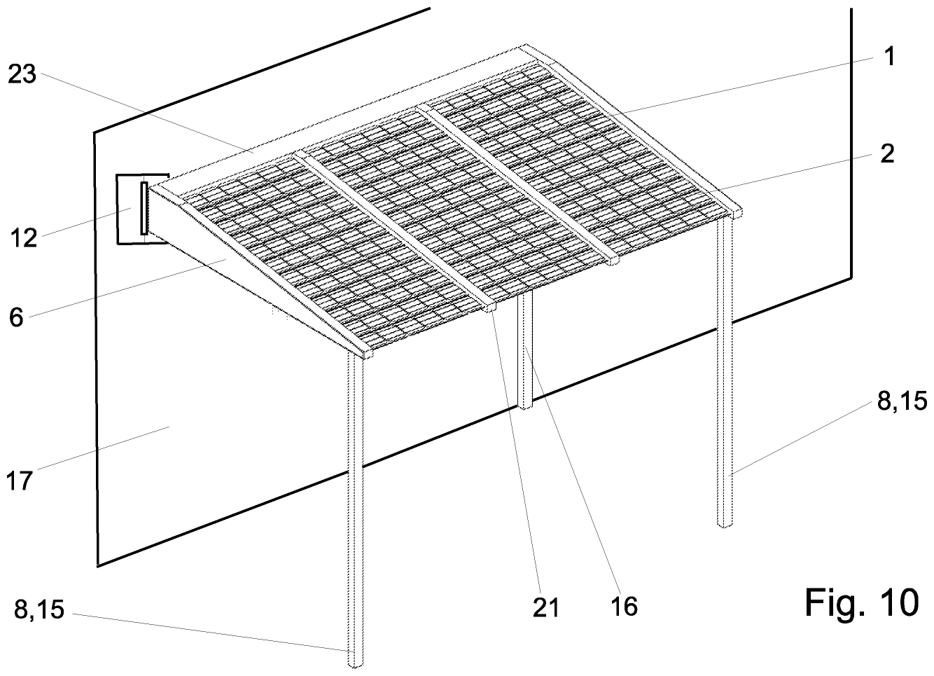

FIG. 10 shows an elevated three-surface shingle array 1 mounted on a wall surface 17 with a simple hinge structure 12 (shown here with a simple hinge design for pivoting up to 90 degrees to the left). Here it is possible, with very little effort, to align the shingle array according to the position of the sun and to be able to follow, at least partially, the changing position of the sun during the day. The two telescopic supports 8 and the wall telescopic support 16 of the telescopic support system 15 can, if necessary, be provided with rollers at the bottom so that the lateral pivoting can be effected by hand with little force. The telescopic support system 16 or rigid support system can be designed to be detachable so that the rectangular strip modules 2 can be drawn in and stowed in the shingle box 23 together and on top of one another. The interconnection of the rectangular strip modules 2 is realized, for example, via flexible plug connections and lines or via a lateral interconnection. The longitudinal rails allow sufficient mechanical stability.

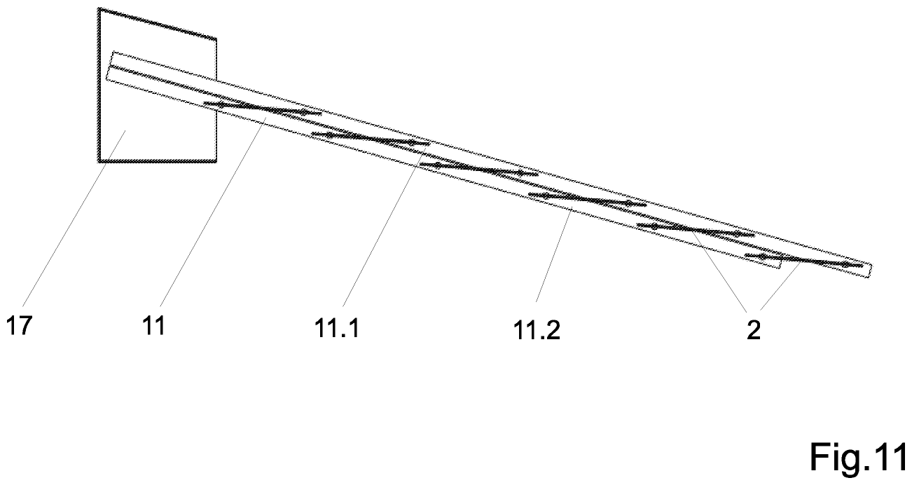

FIG. 11 schematically shows a preferred simple double rail 11 for erecting, i.e., inclining, six rectangular strip modules 2 fastened to the double rail 11 at pivot points. Each rectangular strip module 2 is guided in at least one pivot point both on the upper rail 11.1 and on the lower rail 11.2. If the lower rail 11.1 is moved forward away from the vehicle or wall surface 17 with respect to the upper rail 11.2, the rectangular strip modules 2 are positioned upward and the angle of incidence with respect to the sun rays can be optimized. The movement of the lower rail 11.2 with respect to the upper rail 11.1 is effected via a suitable mechanism. This is possible, for example, by means of cams arranged on the left and right, which can be driven by means of a cable pull or also by a motor. The pivot points in the upper and lower rails 11.1 and 11.2 can also be arranged in a sliding manner in separate slots in the double rails 11. It is also possible that the rectangular strip modules 2 are connected to the double rails via additional intermediate curved lever arms to be able to adjust the shingle-like superposition of the rectangular strip modules. The rectangular strip modules 2 can also be designed to be slightly curved, so that the shingle overlay is achieved through this curvature. The double rail system of, for example, two symmetrically designed double rails 11 can be folded or optionally also removed from the vehicle or wall surface 17 when the rectangular strip modules are retracted. The result is a closed shingle array of crystalline and thin-film solar cells connected in series or in parallel in the manner of a canopy, which is designed to be easy to install, conveniently extendable, easy to transport or arranged.

### LIST OF REFERENCE NUMERALS

1 Shingle array

2 Rectangular strip module

3 Thin film solar cell

4 Sliding contact

5 Rail system

6 Longitudinal rail/telescopic

7 Front rail

8 Telescopic support

9 Depressions or through openings

10 Elevations, balls, or pins

11 Double rail

11.1 Upper rail

11.2 Lower rail

12 Joint construction

15 Telescopic support system

16 Extendable wall telescopic support

17 Vehicle or wall surface

18 Outer edge

19 Long side

20 Short side

21 Intermediate rail

22 Vehicle

23 Shingle box

1. Movable shingle array (1) of rectangular strip modules (2) fitted with crystalline and thin-film solar cells (3) on optionally different carrier materials, wherein support structures for holding and moving in an extendable or fold-out rail system (5) are arranged under the rectangular strip modules (2) along at least two outer edges (18),
characterized in that
one row, two rows, or several rows of crystalline and thin-film solar cells (3) arranged next to each other are arranged interconnected in a rectangular strip module (2), two or more rectangular strip modules (2) overlap each other in the manner of shingles when they are extended,
contacts (11) are formed on the outside of the short side of each rectangular strip module (2),
the contacts (11) are arranged on the short side directly laterally in or on the rectangular strip module (2) or in the rail system (5),
wherein each rectangular strip module (2) is individually contacted and connected, in that a defined hole structure consisting of depressions or through openings (9) is arranged along a long side (19) of the rectangular strip module (2),
in that elevations or pins (10) of a next arranged rectangular strip module (2) (for example studs/spikes) engage in the openings (9) of the hole structure, and
in that the rectangular strip modules (2) are coupled to one another via a cable pull (14) or a rail system (15) or via an articulated arm, and
in that, by means of the cable pull (14) or a rail system (15) or an articulated arm, the rectangular strip modules (2) are designed to be extendable and retractable or adjustable and/or erectable and alignable.

2. Movable shingle array (1) comprised of rectangular strip modules (2) fitted with crystalline and thin-film solar cells (3) according to claim 1,
characterized in that
the shingle array (1) of rectangular strip modules (2) is designed as a single, double, or multi-surface shingle roof and is connected via intermediate rails (21).

3. Movable shingle array (1) comprised of rectangular strip modules (2) fitted with crystalline and thin-film solar cells (3) according to claim 1.
characterized in that
the shingle array (1) can be set up and aligned manually or automatically via a supporting telescopic structure as a function of the angle of the solar radiation.

4. Movable shingle array (1) comprised of rectangular strip modules (2) fitted with crystalline and thin-film solar cells (3) according to claim 1,
characterized in that
the shingle array (1) can be set up manually or automatically as an entire multi-surface shingle roof as a function of the angle of the solar radiation.

5. Movable shingle array (1) comprised of rectangular strip modules (2) fitted with crystalline and thin-film solar cells (3) according to claim 1,
characterized in that
only every second rectangular strip module (2) is equipped or the rectangular strip modules (2) are only partially equipped with crystalline and thin film solar cells (3).

6. Movable shingle array (1) comprised of rectangular strip modules (2) fitted with crystalline and thin-film solar cells (3) according to claim 1,
characterized in that
the shingle array (1) is sensor-controlled, i.e., designed with at least one rain sensor and at least one wind sensor for monitoring.

7. Movable shingle array (1) comprised of rectangular strip modules (2) fitted with crystalline and thin-film solar cells (3) according to claim 1,
characterized in that
lighting is arranged under the shingle roof array (1).

8. Movable shingle array (1) comprised of rectangular strip modules (2) fitted with crystalline and thin-film solar cells (3) according to claim 1,
characterized in that
that when arranged on vehicles, the pull-out or extendable shingle array (1) is arranged on both sides or on three sides.

9. Movable shingle array (1) comprised of rectangular strip modules (2) fitted with crystalline and thin-film solar cells (3) according to claim 1,
characterized in that
the shingle array (1) of rectangular strip modules (2) is arranged in a fixedly lockable manner on only one side by means of a hinge construction (12), so that it is designed in each case to be pivotable through an angle of up to 90° about the hinge construction (12), including the supporting construction.

10. Movable shingle array (1) comprised of rectangular strip modules (2) fitted with crystalline and thin-film solar cells (3) according to claim 1,
characterized in that
each rectangular strip module (2) is individually connected to a bypass diode (13).

11. Movable shingle array (1) comprised of rectangular strip modules (2) fitted with crystalline and thin-film solar cells (3) according to claim 1,
characterized in that
the contacting of the rectangular strip modules (1) takes place via spring contacts arranged in the longitudinal rails, via pin contacts arranged in the longitudinal rails or via sliding contacts or via arranged individual plug connections.

12. Movable shingle array (1) comprised of rectangular strip modules (2) fitted with crystalline and thin-film solar cells (3) according claim 1,
characterized in that
on or under the lateral outer edges (18) and on the telescopic supports (8) on the support structure, additional tent tarpaulins are arranged are arranged to enclose these for lateral weather protection.

13. Interlocking shingle array (1) comprised of rectangular strip modules (2) fitted with crystalline and thin-film solar cells (3) on optionally different carrier materials, wherein support structures for holding and moving in an extendable or fold-out rail system (5) are arranged under the rectangular strip modules (2) along at least two outer edges (18),
characterized in that
a number of interconnected crystalline and thin-film solar cells (3) are arranged next to each other in a rectangular strip module (2),
two or more rectangular strip modules (2) overlap each other in the manner of shingles when they are extended,
contacts (11) are formed on the outside of the short side (20) of each rectangular strip module (2),
the contacts (11) are arranged on the short side directly laterally in or on the rectangular strip module (2) or in the rail system (5),
wherein each rectangular strip module (2) is individually contacted and connected, in that a defined hole structure consisting of depressions or through openings (9) is arranged along a long side (19) of the rectangular strip module (2),
in that elevations or pins (10) of a next arranged rectangular strip module (2) (for example studs/spikes or snap fastener connections) engage in the depressions or openings (9) of the hole structure and
in that the rectangular strip modules (2) are manually interconnected with one another via the recesses or through-openings (9) and the corresponding elevations or pins (10) to form a shingle roof,
wherein the individual rectangular strip modules (2) form a closed shingle roof and the rectangular strip modules (2) are connected via separate flexible copper connectors via one or two laterally arranged busbars and are connected to an energy collection unit or connected consumers via an electrical switching center.
